(19) United States
(12) Patent Application Publication
(10) Pub. No.: US 2025/0110150 A1
(43) Pub. Date: Apr. 3, 2025

(54) IMPACT DETECTION APPARATUS AND IMPACT DETECTION METHOD

(71) Applicant: Panasonic Automotive Systems Co., Ltd., Kanagawa (JP)

(72) Inventors: Masaya NAKAMURA, Kanagawa (JP); Toru MUGIUDA, Osaka (JP); Noriyuki SHIMIZU, Kanagawa (JP); Hisato TAKEUCHI, Kanagawa (JP)

(21) Appl. No.: 18/896,609

(22) Filed: Sep. 25, 2024

(30) Foreign Application Priority Data
Sep. 29, 2023 (JP) 2023-170653

(51) Int. Cl. G01P 7/00

(52) U.S. Cl. CPC G01P 7/00

(57) ABSTRACT

An impact detection apparatus of the present disclosure includes: a storage circuit that stores a velocity and an acceleration of a vehicle in association with an elapse of time; and a determination circuit that determines whether an impact is applied to the vehicle at each timing in a predetermined period based on a variation rate of the acceleration in the predetermined period.

### TECHNICAL FIELD

The present disclosure relates to an impact detection apparatus and an impact detection method of detecting an impact applied to a vehicle.

### BACKGROUND ART

In the related art, a known apparatus detects offense to a vehicle. An example of such an apparatus is an offense detection apparatus capable of detecting the occurrence of a hit-and-run and identifying the offending vehicle when a hit-and-run against one's own vehicle occurs. The offense detection apparatus detects the occurrence of a hit-and-run and specifies the offending vehicle through detection of an impact with an impact detection means, and image-capturing and recording of the direction of the impact with a camera.

### CITATION LIST

### Patent Literature

### PTL 1

JP 2006-302017 A

### SUMMARY OF INVENTION

An impact detection apparatus according to an embodiment of the present disclosure includes: a storage circuit that stores an acceleration generated in a vehicle in association with an elapse of time; and a determination circuit that determines whether an impact is applied to the vehicle at each timing in a predetermined period based on a variation rate of the acceleration in the predetermined period.

An impact detection apparatus according to an embodiment of the present disclosure includes: a storage circuit which, in operation, stores a velocity and an acceleration of a vehicle in association with an elapse of time; and a determination circuit which, in operation, determines whether an impact is applied to the vehicle at a first timing based on whether the acceleration at the first timing is equal to or larger than a predetermined acceleration threshold. The determination circuit changes the acceleration threshold based on the velocity at a second timing, the second timing being a timing after an elapse of a predetermined time from the first timing.

An impact detection method according to an embodiment of the present disclosure includes: storing an acceleration generated in a vehicle in association with an elapse of time; and determining whether an impact is applied to the vehicle at each timing in a predetermined period based on a variation rate of the acceleration in the predetermined period.

An impact detection method according to an embodiment of the present disclosure includes: storing a velocity and an acceleration of a vehicle in association with an elapse of time; and determining whether an impact is applied to the vehicle at a first timing based on whether the acceleration at the first timing is equal to or larger than a predetermined acceleration threshold, in a determination whether an impact is applied to the vehicle, the acceleration threshold is changed based on the velocity at a second timing, the second timing being a timing after an elapse of a predetermined time from the first timing.

### Advantageous Effects of Invention

According to an embodiment of the present disclosure, an impact applied to a vehicle can be detected with high accuracy.

### BRIEF DESCRIPTION OF DRAWINGS

FIG. 1 is a diagram illustrating an exemplary configuration of an impact detection system according to Embodiments 1 and 2 of the present disclosure;

FIG. 2 is a block diagram illustrating an exemplary functional configuration of an impact detection apparatus according to Embodiment 1;

FIG. 3 is a flowchart of a determination process by a determiner according to Embodiment 1;

FIGS. 4A and 4B are diagrams illustrating examples of the acceleration generated in a vehicle;

FIG. 5 is a diagram illustrating the relationship between the acceleration, the jerk, and the impact value occurred in a vehicle in each of a case where an impact is applied to the vehicle, a case where there is a shake due to the parking of the vehicle in a mechanical parking lot, and a case where there is a shake at the vehicle due to wind;

FIG. 6 is a flowchart for describing an example of the overall operation of the impact detection apparatus;

FIG. 7A is a diagram illustrating a relationship between the jerk and the acceleration in a case where a predetermined value for discriminating the detection timing from others is a constant value, and FIG. 7B is a diagram illustrating a relationship in a case where the predetermined value is varied;

FIG. 8 is a block diagram illustrating an exemplary functional configuration of an impact detection apparatus according to Embodiment 2;

FIG. 9 is a diagram illustrating an example of the acceleration before and after filtering and the velocity calculated by a velocity calculator in a case where an impact is applied to vehicle V and a case where vehicle V is parked in a mechanical parking lot;

FIG. 10 is a diagram for describing the calculation of velocity by a velocity calculator according to Embodiment 2;

FIG. 11 is a flowchart of a determination process by a determiner according to Embodiment 2;

FIG. 12 is a diagram for describing a relationship between the first timing and the second timing in Embodiment 2; and

FIG. 13 is a flowchart for describing an overall operation example of the impact detection apparatus according to Embodiment 2.

### DESCRIPTION OF EMBODIMENTS

The following is a detailed description of each embodiment of the present disclosure with reference to the drawings. However, explanations that are more detailed than necessary, for example, detailed explanations of already well-known matters or duplicate explanations of substantially identical configurations, may be omitted.

### Summary

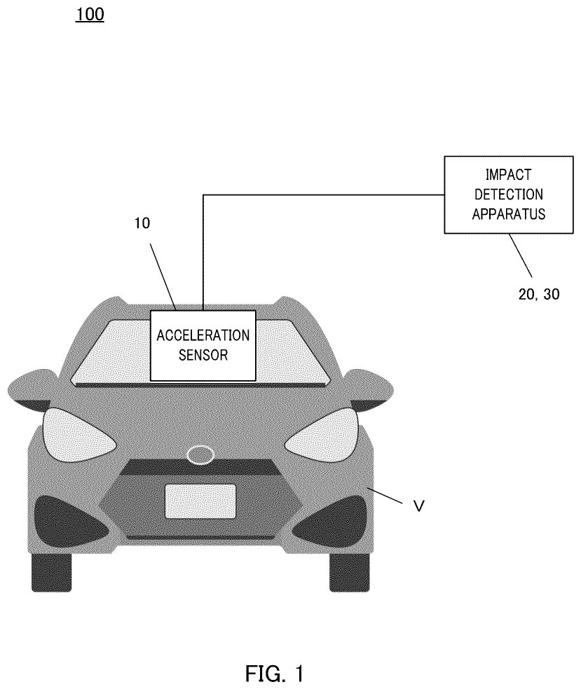

FIG. 1 is a diagram illustrating an exemplary configuration of impact detection system 100 according to Embodiments 1 and 2 of the present disclosure. Impact detection system 100 includes acceleration sensor 10 installed inside vehicle V, and impact detection apparatuses 20 and 30. Note that impact detection apparatus 20 corresponds to Embodiment 1, and impact detection apparatus 30 corresponds to Embodiment 2.

In the example illustrated in FIG. 1, impact detection apparatuses 20 and 30 are installed outside vehicle V, and acceleration sensor 10 and impact detection apparatuses 20 and 30 are communicatively connected to each other in a wired or wireless manner. Impact detection apparatus 20 is a computer including, for example, a processor, a storage device, and input means. Note that the present disclosure is not limited to a mode in which impact detection apparatuses 20 and 30 are installed outside vehicle V; impact detection apparatuses 20 and 30 may also be installed inside vehicle V in the present disclosure.

Acceleration sensor 10 detects the acceleration generated in vehicle V. Acceleration sensor 10 detects the acceleration generated in vehicle V per unit time and outputs acceleration information indicating the magnitude of the detected acceleration to impact detection apparatuses 20 and 30.

Impact detection apparatuses 20 and 30 detect a fact that an impact has been applied to vehicle V based on the acceleration information input from acceleration sensor 10. In the present specification, the term “impact” refers to a phenomenon where a large acceleration is generated instantaneously in vehicle V due to collision of an object with vehicle V or mischief against vehicle V. Examples of objects that collide with vehicle V at the time of impact include a person, a bicycle, or another vehicle.

Note that, an acceleration generated in vehicle V may be detected by acceleration sensor 10 for reasons other than an impact applied to vehicle V. For example, when vehicle V is shaken by wind, an earthquake, or the like, the acceleration generated in vehicle V can be detected by acceleration sensor 10. Further, in a case where vehicle V is parked in a location such as a mechanical parking lot where the parking space itself moves, the acceleration generated in vehicle V can be detected by acceleration sensor 10.

Note that, in the present specification, a mechanical parking lot refers to a parking lot in which a pallet for parking a vehicle moves while the vehicle is parked. The mechanical parking lot in the present specification includes a ground two-stage type, a pit two-stage type (an apparatus having an underground structure), a vertical/horizontal type, a vertical circulation type, and an elevator type (according to the classification by the Japan Parking System Industry Association). Note that the following embodiments assume that the mechanical parking lot is a vertical circulation parking lot, e.g., a so-called tower parking.

An object of the present disclosure is to provide impact detection apparatuses 20 and 30 capable of accurately detecting a fact that an impact has been applied to vehicle V and preventing erroneous detection of an impact on vehicle V when acceleration is generated in vehicle V due to wind, an earthquake, movement of a parking space, or the like.

### Embodiment 1

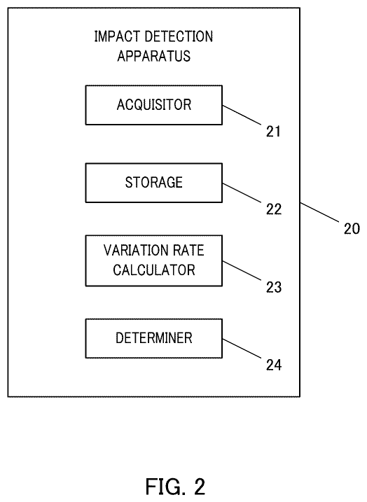

Hereinafter, impact detection apparatus 20 according to Embodiment 1 of the present disclosure will be described. FIG. 2 is a block diagram illustrating an exemplary functional configuration of impact detection apparatus 20 according to Embodiment 1.

Impact detection apparatus 20 includes acquisitor 21, storage 22, variation rate calculator 23, and determiner 24.

Acquisitor 21 acquires acceleration information from acceleration sensor 10 illustrated in FIG. 1. Note that acquisitor 21 may further acquire information other than acceleration information from a configuration other than acceleration sensor 10. For example, acquisitor 21 may acquire velocity information of vehicle V from a velocity sensor installed inside vehicle V.

Storage 22 stores the acceleration generated in vehicle V in association with the elapse of time. Storage 22 stores acceleration information acquired from acceleration sensor 10 per unit time with the time at which the acceleration information is generated (or the time at which the acceleration information is acquired) in such a manner that the acceleration information and the time are associated with each other, for example. In the present disclosure, the unit time may be set to, but not limited to, one second, for example.

Variation rate calculator 23 calculates the variation rate of the acceleration per unit time based on the information relating to the acceleration and the elapse of time stored in storage 22.

Variation rate calculator 23 calculates the variation rate using the following equation 1, for example.

$$\vert J [ n ] \vert = \vert {a}_{impact} [ n ] - {a}_{impact} [ n - 1 ] \vert \qquad ( 1 )$$

n indicates which number of sample out of the samples obtained by sampling acceleration information stored in storage 22 per unit time. n is an integer value. J[n] represents the variation rate of acceleration in the n-th sample. a_{impact}[n] is the impact value at the n-th sample, and a_{impact}[n−1] is the impact value at the (n−1)-th sample. Note that the impact value is calculated by subtracting the gravitational acceleration from the acceleration in the sample.

J[n] calculated by variation rate calculator 23 is the variation rate of the acceleration per unit time, e.g., the jerk. In the example described above, variation rate calculator 23 calculates the jerk based on the difference between the accelerations (impact values) of adjacent samples sampled per unit time. However, the present disclosure is not limited to this. For example, variation rate calculator 23 may calculate the jerk by differentiating the variation rate of the acceleration with time, without performing sampling.

Determiner 24 determines whether an impact has been applied to vehicle V based on the variation rate of the acceleration (jerk) at each timing included in the predetermined period. The predetermined period is a timing to be subjected to the detection of impact detection apparatus 20. The predetermined period is a period that is arbitrarily set in the determination process by the determiner 24, and is, for example, a period from the present to several seconds or several tens of seconds ago.

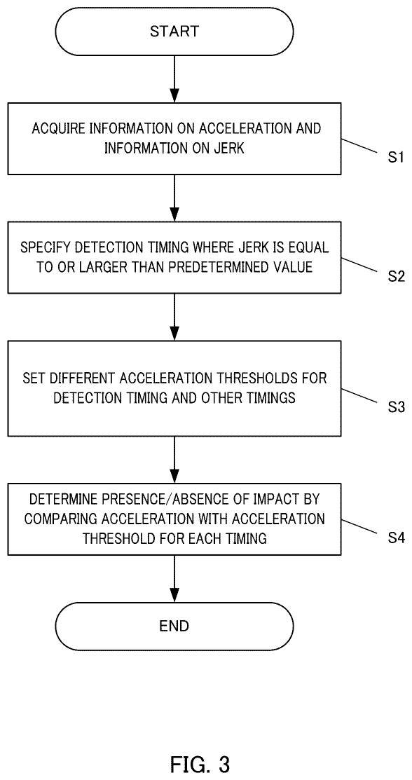

Specifically, determiner 24 determines whether an impact has been applied to vehicle V through the following procedure. FIG. 3 is a flowchart of the determination process by determiner 24.

First, in step S1, determiner 24 acquires information on the acceleration generated in vehicle V in a predetermined period and information on the jerk in the predetermined period calculated by variation rate calculator 23 based on the acceleration.

Next, in step S2, determiner 24 specifies the timing where the jerk becomes equal to or larger than a predetermined threshold in the predetermined period. Hereinafter, the timing where the jerk becomes equal to or larger than a predetermined value will be referred to as the detection timing. The predetermined value is a threshold of the jerk that is set in advance. The method of setting the predetermined value will be described later.

Next, in step S3, determiner 24 sets a predetermined threshold for determining whether an impact has been applied to the vehicle in the predetermined period. The predetermined threshold is a threshold for determining whether an impact has been applied through comparison with the acceleration set in advance. Hereinafter, the threshold for comparison with the acceleration used in step S3 will be referred to as the acceleration threshold. The acceleration threshold is set to different values for the detection timing and timings other than the detection timing.

Specifically, for a timing where the variation rate (jerk) of the acceleration is less than a predetermined value in a predetermined period, such as a timing other than the detection timing, determiner 24 sets the acceleration threshold to a first value. On the other hand, for a detection timing where the variation rate of the acceleration is equal to or larger than the predetermined value, determiner 24 sets the acceleration threshold to a second value smaller than the first value.

In step S4, determiner 24 determines whether an impact has been applied to vehicle V by using the threshold set in step S3 and information on the acceleration in the predetermined period. Specifically, at each timing in the predetermined period, the determiner 24 determines that an impact has been applied to vehicle V at that timing if the acceleration exceeds the threshold.

By such a determination method, determiner 24 can accurately detect whether an impact has been applied to vehicle V and can prevent erroneous detection of an impact on vehicle V when acceleration is generated due to wind, an earthquake, or movement of a parking space or the like on vehicle V.

Hereinafter, effects of the impact determination method performed by determiner 24 will be described with specific examples.

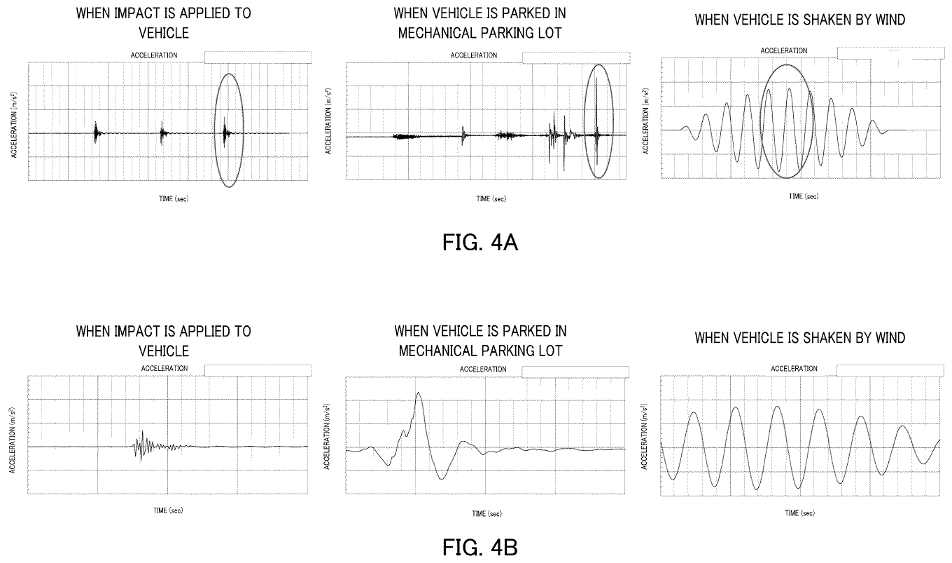

FIG. 4 is a diagram illustrating an example of the acceleration generated in vehicle V. FIG. 4A is a graph illustrating examples of accelerations of the case where an impact is applied to vehicle V, the case where there is a shake due to the parking of vehicle V in a mechanical parking lot, and the case where there is a shake at vehicle V due to the wind. In FIG. 4A, the part surrounded by a circle indicates the timing of a variation in the acceleration, e.g., the timing where an impact has been applied to vehicle V, or the timing where a movement of the parking pallet or a shake due to wind has been generated in vehicle V. FIG. 4B is a graph illustrating a part (a portion surrounded by a circle) of FIG. 4A enlarged in the time direction.

In the examples illustrated in FIGS. 4A and 4B, the variation amount of the acceleration of the case where an impact is applied to vehicle V is smaller than the variation amount of the acceleration of the case where there is a shake due to the parking of vehicle V in a mechanical parking lot and the case where there is a shake at vehicle V due to the wind. For example, in the examples illustrated in FIGS. 4A and 4B, it is difficult to accurately determine whether an impact has been applied to vehicle V based on the variation amount of the acceleration.

Referring to FIG. 4B, it is evident that in the case where an impact is applied to vehicle V, the variation in acceleration is more abrupt, e.g., the variation rate of acceleration is greater than in the case where there is a shake due to the parking of vehicle V in a mechanical parking lot and the case where there is a shake at vehicle V due to the wind. The reason for this is that the shake due to the parking of vehicle V in a mechanical parking or the shake due to the wind is a motion of the entire vehicle and an abrupt variation in acceleration is less likely to appear due to the influence of the inertia (mass) and the size of the vehicle. In contrast, the impact is a force acting on a part of the vehicle, and the instantaneous deformation of the vehicle appears as an acceleration.

For these reasons, determiner 24 determines the presence or absence of an impact on vehicle V based on the variation rates of acceleration of the case where an impact is applied to vehicle V, the case where there is a shake due to the parking of vehicle V in a mechanical parking lot, and the case where there is a shake at vehicle V due to the wind.

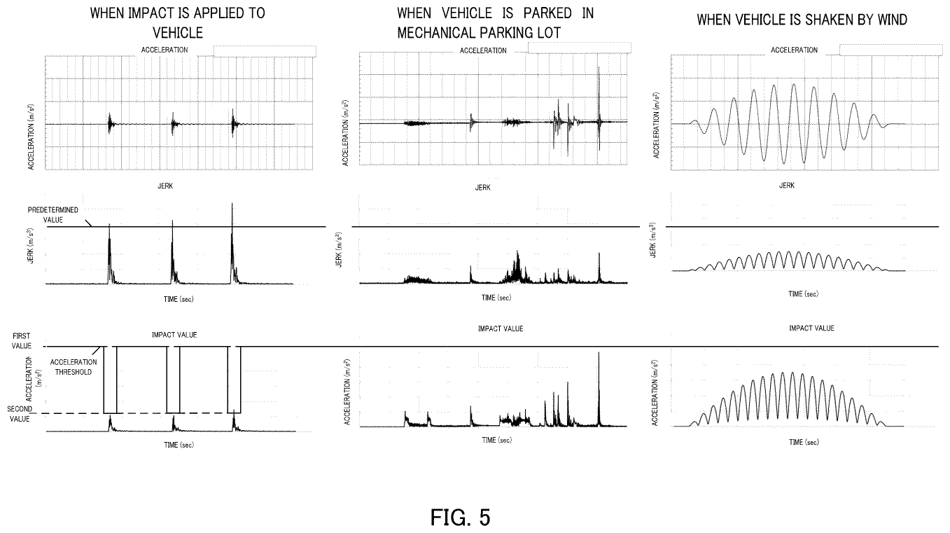

FIG. 5 is a diagram illustrating a relationship between the acceleration, the jerk, and the impact value generated in vehicle V in the case where an impact is applied to vehicle V, the case where there is a shake due to the parking of vehicle V in a mechanical parking lot, and the case where there is a shake at vehicle V due to the wind.

On the left side of FIG. 5, a graph representing the acceleration generated in vehicle V in the case where an impact is applied to vehicle V is illustrated in the upper stage, a graph representing the jerk calculated based on the acceleration is illustrated in the middle stage, and a graph representing the impact value calculated by subtracting the gravitational acceleration from the acceleration generated in vehicle V is illustrated in the lower stage.

At the middle of FIG. 5, a graph representing the acceleration generated in vehicle V in the case where there is a shake due to the parking of vehicle V in a mechanical parking lot is illustrated in the upper stage, a graph representing the jerk calculated based on the acceleration is illustrated in the middle stage, and a graph representing the impact value calculated by subtracting the gravitational acceleration from the acceleration generated in vehicle V is illustrated in the lower stage.

On the right side FIG. 5, a graph representing the acceleration generated in vehicle V in the case where there is a shake at vehicle V due to the wind is illustrated in the upper stage, a graph representing the jerk calculated based on the acceleration is illustrated in the middle stage, and a graph representing the impact value calculated by subtracting the gravitational acceleration from the acceleration generated in vehicle V is illustrated in the lower stage.

Note that the upper graphs in FIG. 5 (each graph indicating the acceleration generated in vehicle V in each case) are the same as those illustrated in FIG. 4A.

Referring to the graph illustrating the jerk of each case in the middle stage of FIG. 5, the jerk in the case where an impact is applied to vehicle V is larger overall than in the other cases. This is because, generally, in the case where an impact is applied to vehicle V, there is an abrupt acceleration variation, e.g., a larger jerk than in the case where there is a shake due to the parking of vehicle V in a mechanical parking lot and the case where there is a shake at vehicle V due to the wind, as described above with reference to FIG. 4.

Here, the predetermined value that is a threshold for the jerk and is used for the processing in step S2 in FIG. 3 may be set to a constant value (see the “predetermined value” illustrated in FIG. 5) smaller than the peak of the jerk of the case where there is an impact on vehicle V, and larger than the peak of the jerk of the case where there is a shake due to the parking of vehicle V in a mechanical parking lot or the case where there is a shake at vehicle V due to the wind. Thus, through the processing in step S2 in FIG. 3, determiner 24 can accurately discriminate between the detection timing with a high possibility of a change occurred in the acceleration generated due to an impact applied to vehicle V and the timing a high possibility of a change occurred in the acceleration generated due to the movement of the parking pallet or the shake of vehicle V due to the wind.

The graph showing the impact value in each case in the lower stage of FIG. 5 illustrates a threshold of the acceleration set by the processing in step S3 in FIG. 3. In the graph in the lower stage of FIG. 5, the first value, which is the threshold for a timing other than the detection timing, is indicated with a solid line, and the second value, which is the threshold for the detection timing, is indicated with a broken line. The first value may be set in advance by experimentation or the like to a value slightly larger than the maximum value of the acceleration (impact value) that is generated in vehicle V due to a mechanical parking lot or wind, for example. Further, the second value may be set in advance by experimentation or the like to a value slightly smaller than the maximum value of the acceleration (impact value) that is generated in vehicle V due to an impact actually applied to vehicle V, for example.

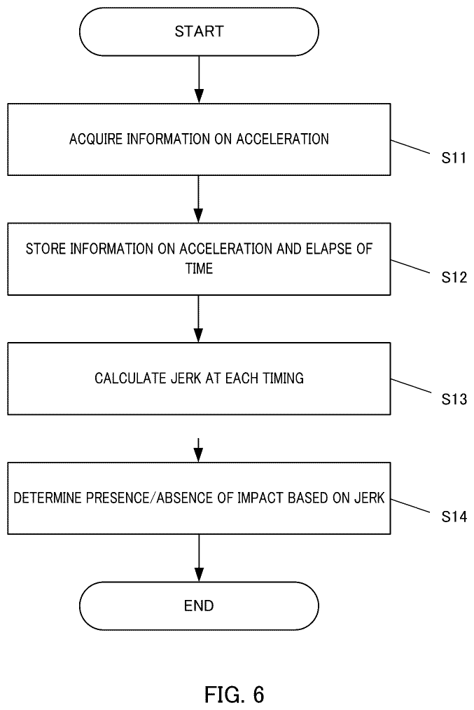

FIG. 6 is a flowchart for describing an overall operation example of impact detection apparatus 30.

In step S11, acquisitor 21 acquires information on the acceleration from acceleration sensor 10 of vehicle V.

In step S12, storage 22 stores information on the acceleration and the elapse of time in the predetermined period.

In step S13, variation rate calculator 23 calculates the jerk at each timing in the predetermined period based on the information stored in storage 22.

In step S14, determiner 24 determines whether an impact has been applied to vehicle V based on the jerk at each timing.

As described above, according to impact detection apparatus 20 of Embodiment 1 of the present disclosure, it is possible to accurately discriminate between the case where an impact is applied to vehicle V, the case where there is a shake due to the parking of vehicle V in a mechanical parking lot, and the case where there is a shake at vehicle V due to the wind on the basis of the acceleration and the jerk at each timing in the predetermined period. Thus, it is possible to determine in advance whether an impact is likely to have been applied to vehicle V at each timing. Thereafter, based on the result of the aforementioned determination, the acceleration threshold for determining the presence or absence of an impact using the acceleration (impact value) is changed for timings with a high possibility of an impact on vehicle V and other timings, and then the presence or absence of the impact is determined through comparison between the acceleration and the acceleration threshold for each timing, thereby enabling accurate detection of an impact on vehicle V.

### Variations

Hereinafter, a variation of Embodiment 1 will be described.

In Embodiment 1, the determiner 24 accurately detects an impact applied on vehicle V by discriminating between the detection timing with a high possibility of an impact on vehicle V and other timings based on information on the jerk in a predetermined period, and changing the acceleration threshold for determining the presence or absence of an impact due to acceleration for the detection timing and the timing other than the detection timing.

In the present disclosure, instead of changing the acceleration threshold for determination between the detection timing and the timing other than the detection timing, it may be determined that an impact has been applied to the vehicle simply at a timing when the jerk becomes equal to or larger than a predetermined value in a predetermined period.

In this case, the determiner can determine whether an impact has been applied to a vehicle by determining whether the jerk becomes equal to or larger than the predetermined value at each timing in the predetermined period, thus increasing the ease of the processing. In this manner, the calculation resources of the impact detection apparatus can be further reduced, making it possible to provide the impact detection apparatus at a lower cost.

Further, in Embodiment 1, the determiner 24 sets to a constant value set in advance the predetermined value for discriminating between the detection timing with a high possibility that an impact has been applied to vehicle V and other timings. Here, for example, the predetermined value may be changed based on the magnitude of the acceleration at each timing. Thus, the jerk generated by the impact applied to vehicle V and the jerk generated by other factors such as noise can be accurately discriminated from each other.

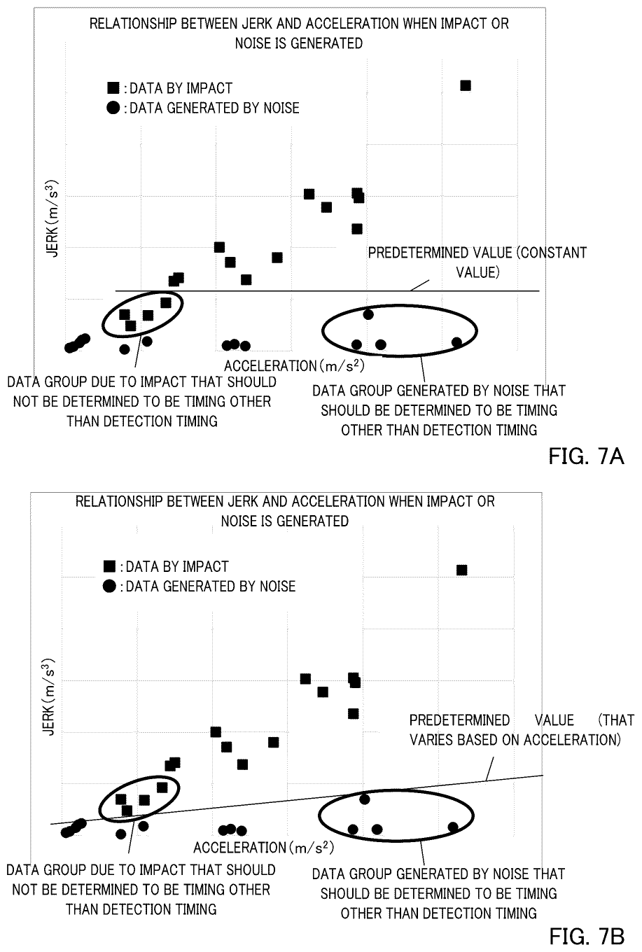

FIG. 7 is a diagram illustrating a relationship between the jerk and the acceleration in the case where the predetermined value for discriminating the detection timing from others is a constant value and the case where that predetermined value is varied. FIG. 7A illustrates a relationship between the jerk and the acceleration in the case where the predetermined value is a constant value, and FIG. 7B illustrates a relationship in the case where the predetermined value is varied based on the acceleration.

In FIGS. 7A and 7B, ▪ (black square) indicates data generated by the impact applied to vehicle V, and ● (black circle) indicates data generated by noise. Further, in FIGS. 7A and 7B, the data with a jerk smaller than a predetermined value corresponds to the timing equal to or less than the predetermined value in the middle stage graph in FIG. 5, which is, in the determination process of determining the presence or absence of the impact in step S4 in FIG. 3, the timing other than the detection timing and is data for which the determination using the first threshold with a larger value is performed.

As illustrated in FIGS. 7A and 7B, in a region of small acceleration, the jerk is also small, and data due to an impact and data generated by noise are mixed. For this reason, if the predetermined value is a constant value as illustrated in FIG. 7A, the jerk of the data due to an impact other than data generated by noise in the small acceleration region may become less than the predetermined value, which may result in erroneous determination to be a timing other than the detection timing.

In contrast, in FIG. 7B, the predetermined value is linearly varied such that the predetermined value becomes larger as the acceleration becomes larger. With the predetermined value set in this manner, it is possible to prevent a situation where data due to an impact is erroneously determined as a timing other than the detection timing in a region where the jerk is small, as illustrated in FIG. 7B.

### Embodiment 2

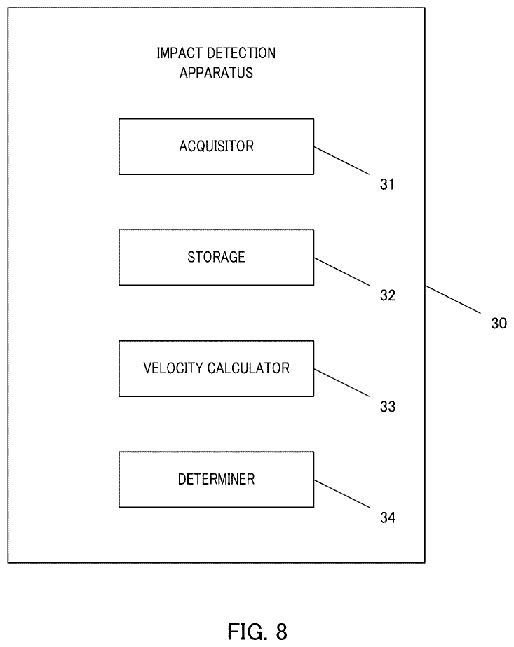

Hereinafter, impact detection apparatus 30 according to Embodiment 2 of the present disclosure will be described. FIG. 8 is a block diagram illustrating an exemplary functional configuration of impact detection apparatus 30 according to Embodiment 2.

Impact detection apparatus 30 includes acquisitor 31, storage 32, velocity calculator 33, and determiner 34.

Acquisitor 31 acquires acceleration information from acceleration sensor 10 illustrated in FIG. 1. Note that acquisitor 31 may further acquire information other than acceleration information from a configuration other than acceleration sensor 10. For example, acquisitor 31 may acquire velocity information of vehicle V from a velocity sensor installed inside vehicle V.

Storage 32 stores the acceleration generated in vehicle V in association with the elapse of time. Storage 32 associates acceleration information acquired from acceleration sensor 10 per unit time with the time at which the acceleration information is generated (or the time at which the acceleration information is acquired), and stores the acceleration information and the time in association with each other, for example.

Velocity calculator 33 calculates the velocity of vehicle V at each timing in the predetermined period based on the information related to acceleration and the elapse of time stored in storage 32.

First, velocity calculator 33 performs filtering on the information regarding acceleration in the predetermined period using a predetermined filter such as a low-pass filter, thereby removing from the information on acceleration the components caused by an impact applied to vehicle V and the components caused by noise.

The type of the low-pass filter used in velocity calculator 33 may be, but not limited to, the filter expressed in the following equation 2, for example.

[1]

$${a}_{Filtered \_ N} = \frac{m - 1}{m} * {a}_{Filtered \_ N - 1} + \frac{1}{m} * {a}_{N} \qquad ( 2 )$$

In equation 2, a_{Filtered_N} is the value of the acceleration in the N-th sample after the filtering, a_{Filtered_N-1} is the value of the acceleration in the N−1-th sample after the filtering, a_{N} is the value of the acceleration in the N-th sample before the filtering, and m is an integer of 2 or more.

Further, velocity calculator 33 calculates the velocity at each timing in the predetermined period by using information on the acceleration after the filtering. Specifically, velocity calculator 33 calculates the velocity of vehicle V at a certain timing T₁ in the predetermined period by integrating the acceleration from a timing T₀ before T₁ to T₁. Note that the length of the section for integrating the velocity to calculate the acceleration, e.g., the time length between timing T₀ and T₁, may be set to an arbitrary value in advance. Timing T₁ is an example of the third timing of the present disclosure.

Velocity calculator 33 calculates the velocity of vehicle V at timing T₁ according to the following equation 3 by using the acceleration after the filtering, for example.

[2]

$$v = {{\int }^{{T}_{1}}}_{{T}_{0}} {a}_{Filtered} dt \approx {\sum }_{{T}_{0}}^{{T}_{1}} {a}_{Filtered \_ N} \qquad ( 3 )$$

In equation 3, v represents the velocity, a_{Filtered} represents the value of the acceleration at each timing after the filtering, and a_{Filtered_N} represents the value of the acceleration at the N-th timing after the filtering in the sample after a predetermined period. In the term at the right end of equation 3, the summation value of the accelerations in all the samples from timing T₀ to T₁ is calculated as an approximate value of the integration value of the accelerations in the section from timing T₀ to T₁.

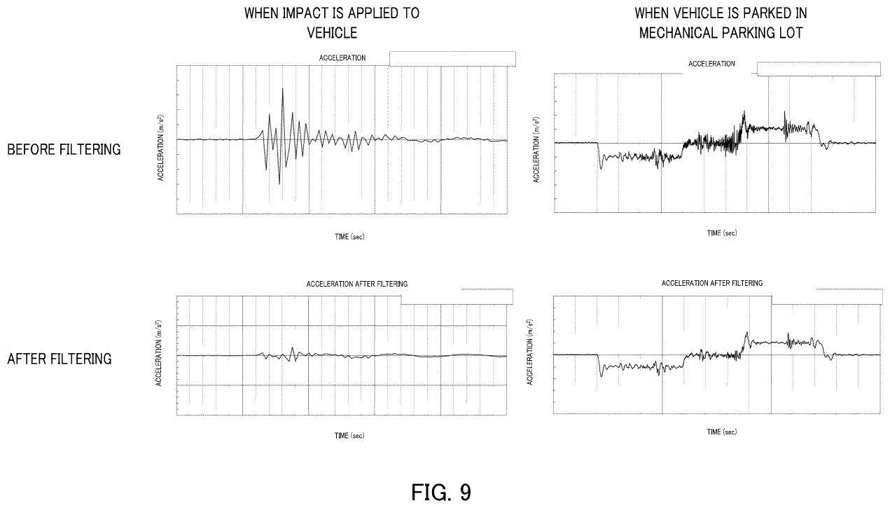

FIG. 9 is a diagram illustrating an example of the acceleration before and after the filtering and the velocity calculated by velocity calculator 33 in the case where an impact is applied to vehicle V and in the case where vehicle V is parked in a mechanical parking lot. In FIG. 9, a graph of the case where an impact is applied to vehicle V is illustrated on the left side, and a graph of the case where vehicle V is parked in a mechanical parking lot is illustrated on the right side. Further, FIG. 9 illustrates a graph representing the acceleration before the filtering in the upper stage, and a graph representing the acceleration after the filtering in the middle stage. FIG. 9 illustrates in the lower stage a graph indicating the velocity calculated by velocity calculator 33 based on the acceleration after the filtering.

As described above, the low-pass filter used by velocity calculator 33 removes the acceleration component due to impact and the noise component, and therefore the acceleration in the case where an impact is applied to vehicle V is substantially 0 after the filtering as illustrated in FIG. 9. Thus, the velocity of vehicle V calculated by velocity calculator 33 becomes substantially 0 in the case where an impact is applied to vehicle V.

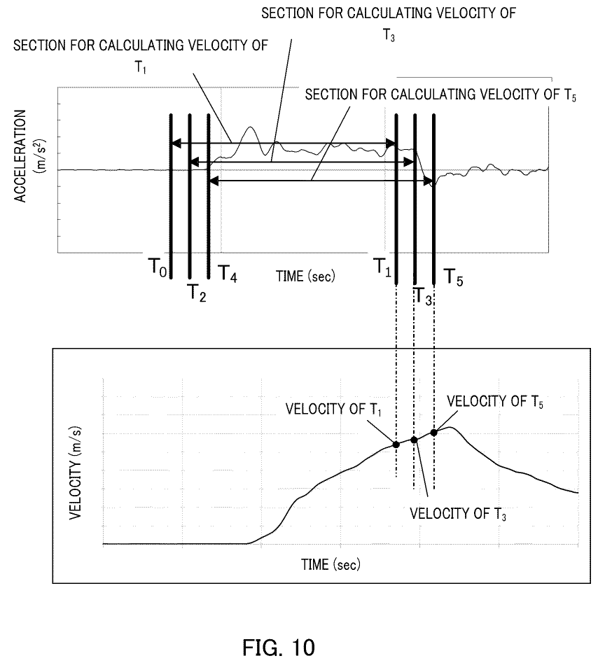

FIG. 10 is a diagram for describing the calculation of the velocity by velocity calculator 33. The upper stage in FIG. 10 is a graph for describing the section in which velocity calculator 33 calculates velocity from acceleration. In the upper stage of FIG. 10, the acceleration from timing T₀ to T₁ is used to calculate the velocity at timing T₁. Further, the acceleration from timing T₂ to T₃ is used to calculate the velocity at timing T₃. Further, the acceleration from timing T₄ to T₅ is used to calculate the velocity at timing T₅. In this manner, velocity calculator 33 integrates the acceleration in an arbitrary section terminating at the specific timing, in order to calculate the velocity at the specific timing in the predetermined period.

The lower stage of FIG. 10 is a graph illustrating a relationship between the velocity calculated by velocity calculator 33 and the elapse of time. The lower stage of FIG. 10 illustrates the velocity at timing T₁, the velocity at timing T₃, and the velocity at timing T₅.

such a calculation method of the velocity can reduce influences due to dark noise and quantization error, and calculate the velocity accurately.

Note that the present disclosure is not limited to the method of calculating the velocity through the integration of the acceleration by the velocity calculator. For example, information on the velocity acquired from a velocity sensor mounted on a vehicle may be used. Note that, in a case where velocity of the vehicle is acquired from the velocity sensor, and the velocity component due to an impact applied to the vehicle is difficult to measure with the velocity sensor, the filtering may not be performed.

Determiner 34 determines whether an impact has been applied to vehicle V at the first timing in the predetermined period based on the velocity at the second timing, which is a timing after an elapse of a predetermined time from the first timing. The first timing is the timing subjected to the determination of determiner 34 in a predetermined period.

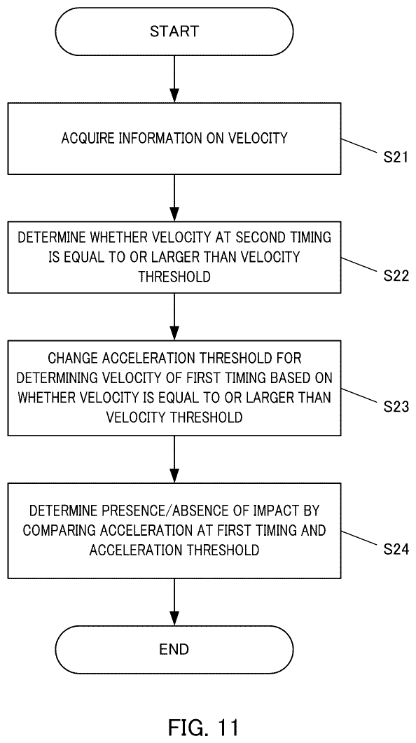

Specifically, the determiner 34 determines whether an impact has been applied to vehicle V through the following procedure. FIG. 11 is a flowchart of the determination process by determiner 34.

First, in step S21, determiner 34 acquires information on the velocity of vehicle V at each timing in the predetermined period.

Next, in step S22, determiner 34 determines whether the velocity at the second timing, at which a predetermined time has passed from the first timing for the determination in the predetermined period, is equal to or larger than a predetermined velocity threshold.

Determiner 34 executes the determination process sequentially for each timing in the predetermined period. The first timing is the timing to be subjected to the processing in the determination process.

The velocity threshold is a threshold used for determining whether the first timing is a timing with a high possibility that an impact has been applied to vehicle V.

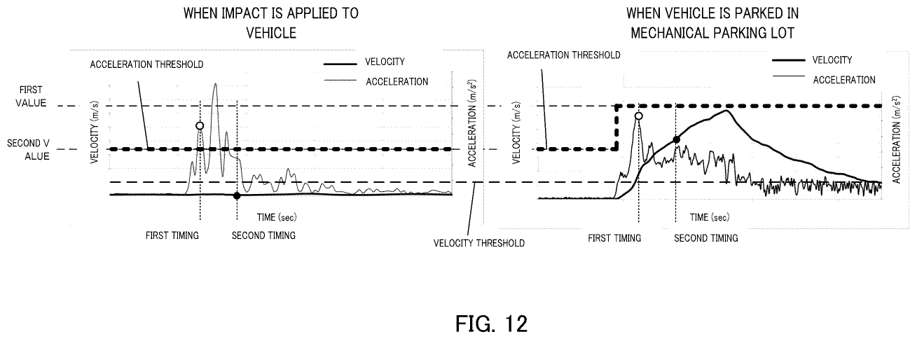

FIG. 12 is a diagram for describing a relationship between the first timing and the second timing. In FIG. 12, the graph on the left side illustrates an example of the velocity change in the case where an impact is applied to vehicle V, and the graph on the right side illustrates an example of the velocity change in the case where vehicle V is parked in a mechanical parking lot.

When an acceleration is generated in vehicle V, a certain amount of time is taken until vehicle V starts moving with the acceleration, e.g., until the velocity of vehicle V becomes greater than 0 because vehicle V has a relatively large mass.

For this reason, the determiner 34 determines whether the first timing is a timing with a high possibility that an impact has been applied to vehicle V by using the velocity at the second timing after the elapse of the predetermined time from the first timing. The acceleration generated in the vehicle in the case where an impact is applied to vehicle V is more abrupt than in other cases. For example, in the case where an impact is applied to vehicle V at the first timing, the velocity of the vehicle at the second timing after the elapse of the predetermined time is considered to be not affected by the impact applied at the first timing, and to be close to 0.

For example, with the velocity threshold set to a value close to 0, in the case where the velocity at the second timing is less than the velocity threshold, the first timing can be specified as the timing with a high possibility that an impact has been applied to vehicle V (see the graph on the left side in FIG. 12). In the case where the velocity at the second timing is equal to or greater than the velocity threshold, the first timing can be determined as the timing with a high possibility that the velocity has been generated in vehicle V due to a factor other than an impact (see the graph on the right side in FIG. 12).

Next, in step S23, based on the determination result in step S22, determiner 34 changes the acceleration threshold for comparison with the acceleration at the first timing to determine whether an impact has been applied to vehicle V at the first timing.

Specifically, in the case where the velocity at the second timing is equal to or greater than the velocity threshold, the possibility that an impact has been applied to vehicle V at the first timing is relatively low, and therefore determiner 34 sets the acceleration threshold to the relatively large first value (see the graph on the right side in FIG. 12). In the case where the velocity at the second timing is less than the velocity threshold, the possibility that an impact has been applied to vehicle V at the first timing is relatively high, and therefore determiner 34 sets the acceleration threshold to a second value smaller than the first value (see the graph on the left side in FIG. 12).

In step S24, determiner 34 determines the presence or absence of the impact at the first timing by comparing the acceleration threshold set in step S23 with the acceleration (impact value) at the first timing. Specifically, the determiner 34 can determine that an impact has been applied to vehicle V at the first timing if the acceleration exceeds the acceleration threshold at the first timing.

By such a determination method, determiner 34 can accurately detect whether an impact has been applied to vehicle V at the first timing and can prevent erroneous detection of an impact on vehicle V when acceleration is generated due to wind, an earthquake, movement of a parking space or the like on vehicle V.

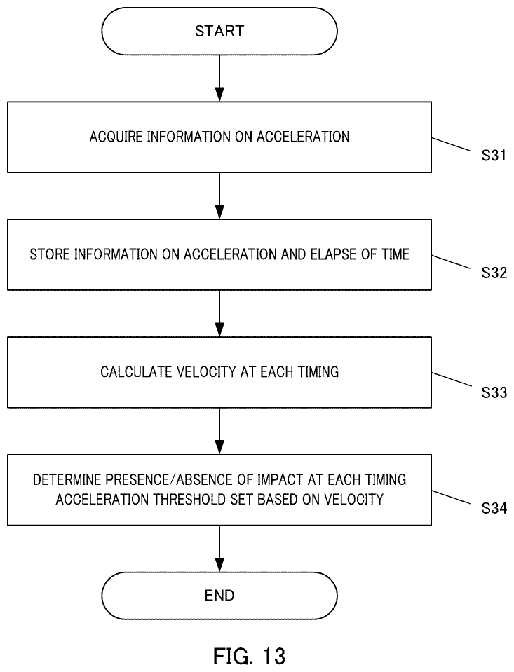

FIG. 13 is a flowchart for describing an overall operation example of impact detection apparatus 30.

In step S31, acquisitor 31 acquires information on the acceleration from acceleration sensor 10 of vehicle V.

In step S32, storage 32 stores information on the acceleration and the elapse of time in the predetermined period.

In step S33, velocity calculator 33 calculates the velocity at each timing in the predetermined period based on information stored in storage 32.

In step S34, determiner 34 determines whether an impact has been applied to vehicle V by using the acceleration threshold set based on the velocity at each timing.

As described above, according to impact detection apparatus 30 of Embodiment 2 of the present disclosure, the acceleration threshold for determining whether an impact has been applied to vehicle V at the first timing in the predetermined period is changed based on the velocity of vehicle V at the second timing after the elapse of the predetermined time from the first timing. In the case where an impact is applied to vehicle V at the first timing, e.g., the case where an abrupt acceleration is generated in vehicle V, the velocity of vehicle V at the second timing after the predetermined time is considered to be close to 0, and therefore in the case where the velocity of vehicle V at the second timing is less than the velocity threshold, the first timing is considered to be a timing with a high possibility that an impact has been applied to vehicle V. On the other hand, in the case where the velocity of vehicle V at the second timing is equal to or greater than the velocity threshold, the first timing is considered to be a timing with a high possibility that the velocity has been generated in vehicle V due to a factor other than an impact.

In view of this, in the case where the velocity of vehicle V at the second timing is less than the velocity threshold, the acceleration threshold for comparison with the acceleration at the first timing is set to the relatively large first value, whereas in the case where the velocity of vehicle V at the second timing is less than the velocity threshold, the acceleration threshold is set to the second value smaller than the first value, and thus, it is possible to highly accurately determine whether an impact has been generated in vehicle V at the first timing by comparing the acceleration of the first timing with the acceleration threshold.

In the above embodiment of the impact detection apparatus, the notation “section” used for each component may be replaced by other notations such as “circuitry”, “assembly”, “device”, “unit”, or “module” as described above.

The impact detection apparatus of the above embodiments may also perform signal control by having a CPU execute a program installed in ROM, for example.

However, the program to be executed by the impact detection apparatus may be an installable or executable format file recorded and provided on a computer-readable recording medium such as CD-ROM, flexible disc (FD), CD-R, DVD (Digital Versatile Disc), and the like. Alternatively, the program may be downloaded via a network and executed on a computer.

At least part of the functions of the impact detection apparatus may be realized by a dedicated hardware circuit that does not have a CPU.

Thus, the impact detection apparatus of the above embodiments can be realized by software, hardware, or software in conjunction with hardware. The impact detection apparatus of the above embodiments may also be realized by a system, device, method, integrated circuit, computer program, or recording medium, and may be realized by any combination of a system, device, method, integrated circuit, computer program, and recording medium. A program product is a computer-readable medium on which a computer program is recorded.

Each functional block of the impact detection apparatus of the above embodiment may be partially or entirely realized as an LSI, which is an integrated circuit, and each processing of the impact detection apparatus of the above embodiment may be partially or entirely controlled by a single LSI or a combination of LSIs. The LSI may consist of individual chips or a single chip to contain some or all of the functional blocks. The LSI may have data inputs and outputs. LSIs are sometimes called ICs, system LSIs, super LSIs, or ultra LSIs, depending on the degree of integration.

However, the method of integrated circuitry is not limited to LSI, but may be realized with dedicated circuits, general-purpose processors or dedicated processors. Field Programmable Gate Array (FPGA), which can be programmed, or reconfigurable processors, which can reconfigure the connections and settings of circuit cells inside the LSI, may also be used after the LSI is manufactured. Each of the above embodiments of the impact detection apparatus may be realized as a digital or analog process.

Furthermore, if an integrated circuit technology replacing LSI appears due to advances in semiconductor technology or another derived technology, the technology may naturally be used to integrate functional blocks. The application of biotechnology, etc. may be a possibility.

An impact detection apparatus of the present disclosure includes: a storage circuit that stores an acceleration generated in a vehicle in association with an elapse of time; and a determination circuit that determines whether an impact is applied to the vehicle at each timing in a predetermined period based on a variation rate of the acceleration in the predetermined period.

In the impact detection apparatus of the present disclosure, the determination circuit determines whether an impact is applied to the vehicle at each timing based on whether the acceleration at each timing in the predetermined period is equal to or larger than a predetermined acceleration threshold, and changes the acceleration threshold used in a determination at each timing based on a variation rate at each timing.

In the impact detection apparatus of the present disclosure, the determination circuit sets the acceleration threshold to a first value in a case where the variation rate is less than a predetermined value, and sets the acceleration threshold to a second value smaller than the first value in a case where the variation rate is equal to or larger than the predetermined value.

In the impact detection apparatus of the present disclosure, the determination circuit changes the predetermined value at each timing in the predetermined period based on the acceleration at each timing.

An impact detection apparatus, of the present disclosure includes: a storage circuit that stores a velocity and an acceleration of a vehicle in association with an elapse of time; and a determination circuit that determines whether an impact is applied to the vehicle at a first timing based on whether the acceleration at the first timing is equal to or larger than a predetermined acceleration threshold. The determination circuit changes the acceleration threshold based on the velocity at a second timing, the second timing being a timing after an elapse of a predetermined time from the first timing.

In the impact detection apparatus of the present disclosure, the determination circuit sets the acceleration threshold to a first value in a case where the velocity at the second timing is equal to or larger than a predetermined velocity threshold, and sets the acceleration threshold to a second value smaller than the first value in a case where the velocity at the second timing is smaller than the velocity threshold.

In the impact detection apparatus of the present disclosure, further includes: a velocity calculation circuit that executes a filtering process on the acceleration of the vehicle and calculates the velocity of the vehicle based on the acceleration after the filtering process.

In the impact detection apparatus of the present disclosure, the velocity calculation circuit calculates the velocity at a third timing by integrating the acceleration in a given period terminating at the third timing.

An impact detection method of the present disclosure includes: storing an acceleration generated in a vehicle in association with an elapse of time; and determining whether an impact is applied to the vehicle at each timing in a predetermined period based on a variation rate of the acceleration in the predetermined period.

An impact detection method of the present disclosure includes: storing a velocity and an acceleration of a vehicle in association with an elapse of time; and determining whether an impact is applied to the vehicle at a first timing based on whether the acceleration at the first timing is equal to or larger than a predetermined acceleration threshold, in a determination whether an impact is applied to the vehicle, the acceleration threshold is changed based on the velocity at a second timing, the second timing being a timing after an elapse of a predetermined time from the first timing.

While various embodiments have been described herein above, it is to be appreciated that various changes in form and detail may be made without departing from the spirit and scope of the invention(s) presently or hereafter claimed.

This application is entitled and claims the benefit of Japanese Patent Application No. 2023-170653, filed on Sep. 29, 2023, the disclosure of which including the specification, drawings and abstract is incorporated herein by reference in its entirety.

### INDUSTRIAL APPLICABILITY

The present disclosure is useful for an impact detection apparatus that determines whether an impact has been applied to a vehicle.

1. An impact detection apparatus, comprising:
a storage circuit which, in operation, stores an acceleration generated in a vehicle in association with an elapse of time; and
a determination circuit which, in operation, determines whether an impact is applied to the vehicle at each timing in a predetermined period based on a variation rate of the acceleration in the predetermined period.

2. The impact detection apparatus according to claim 1,
wherein the determination circuit
determines whether an impact is applied to the vehicle at each timing based on whether the acceleration at each timing in the predetermined period is equal to or larger than a predetermined acceleration threshold, and
changes the acceleration threshold used in a determination at each timing based on a variation rate at each timing.

3. The impact detection apparatus according to claim 2, wherein the determination circuit sets the acceleration threshold to a first value in a case where the variation rate is less than a predetermined value, and sets the acceleration threshold to a second value smaller than the first value in a case where the variation rate is equal to or larger than the predetermined value.

4. The impact detection apparatus according to claim 3, wherein the determination circuit changes the predetermined value at each timing in the predetermined period based on the acceleration at each timing.

5. An impact detection apparatus, comprising:
a storage circuit which, in operation, stores a velocity and an acceleration of a vehicle in association with an elapse of time; and
a determination circuit which, in operation, determines whether an impact is applied to the vehicle at a first timing based on whether the acceleration at the first timing is equal to or larger than a predetermined acceleration threshold,
wherein the determination circuit changes the acceleration threshold based on the velocity at a second timing, the second timing being a timing after an elapse of a predetermined time from the first timing.

6. The impact detection apparatus according to claim 5, wherein the determination circuit sets the acceleration threshold to a first value in a case where the velocity at the second timing is equal to or larger than a predetermined velocity threshold, and sets the acceleration threshold to a second value smaller than the first value in a case where the velocity at the second timing is smaller than the velocity threshold.

7. The impact detection apparatus according to claim 5, further comprising:
a velocity calculation circuit which, in operation, executes a filtering process on the acceleration of the vehicle and calculates the velocity of the vehicle based on the acceleration after the filtering process,
wherein the storage circuit stores the velocity of the vehicle calculated.

8. The impact detection apparatus according to claim 7, wherein the velocity calculation circuit calculates the velocity at a third timing by integrating the acceleration in a given period terminating at the third timing.

9. The impact detection apparatus according to claim 8,
wherein the velocity calculation circuit executes the filtering process using a filter expressed in equation 1,
[3]
$${a}_{Filtered \_ N} = \frac{m - 1}{m} * {a}_{Filtered \_ N - 1} + \frac{1}{m} * {a}_{N} \qquad ( 1 )$$
where a_{Filtered_N} is a value of an acceleration in an N-th sample after the filtering process, a_{Filtered_N-1} is a value of an acceleration in an N−1-th sample after the filtering process, a_{N} is a value of an acceleration in the N-th sample before the filtering process, and m is an integer of 2 or more.

10. The impact detection apparatus according to claim 9,
wherein the velocity calculation circuit calculates the velocity at the third timing according to equation 2,
[4]
$$v = {{\int }^{{T}_{1}}}_{{T}_{0}} {a}_{Filtered} dt \approx {\sum }_{{T}_{0}}^{{T}_{1}} {a}_{Filtered \_ N} \qquad ( 2 )$$
where v is the velocity, a_{Filtered} is a value of an acceleration at each timing after the filtering process, and a_{Filtered_N} is a value of an acceleration at the N-th sample after the filtering process in a predetermined period.

11. An impact detection method, comprising:
storing an acceleration generated in a vehicle in association with an elapse of time; and
determining whether an impact is applied to the vehicle at each timing in a predetermined period based on a variation rate of the acceleration in the predetermined period.

12. The impact detection method according to claim 11,
wherein whether an impact is applied to the vehicle at each timing in the predetermined period is determined based on whether the acceleration at each timing in the predetermined period is equal to or larger than a predetermined acceleration threshold, and
the acceleration at each timing in the predetermined period is changed based on a variation rate at each timing.

13. The impact detection method according to claim 12,
wherein the acceleration threshold is set to a first value in a case where the variation rate is less than a predetermined value, and
wherein the acceleration threshold is set to a second value smaller than the first value in a case where the variation rate is equal to or larger than the predetermined value.

14. The impact detection method according to claim 13, wherein the predetermined value at each timing in the predetermined period is changed based on the acceleration at each timing.

15. An impact detection method, comprising:
storing a velocity and an acceleration of a vehicle in association with an elapse of time; and
determining whether an impact is applied to the vehicle at a first timing based on whether the acceleration at the first timing is equal to or larger than a predetermined acceleration threshold,
wherein in a determination whether an impact is applied to the vehicle, the acceleration threshold is changed based on the velocity at a second timing, the second timing being a timing after an elapse of a predetermined time from the first timing.

16. The impact detection method according to claim 15, wherein the acceleration threshold is set to a first value in a case where the velocity at the second timing is equal to or larger than a predetermined velocity threshold, and the acceleration threshold is set to a second value smaller than the first value in a case where the velocity at the second timing is smaller than the velocity threshold.

17. The impact detection method according to claim 16, wherein the velocity of the vehicle is calculated based on the acceleration after a filtering process, and stored.

18. The impact detection method according to claim 17, wherein the velocity at a third timing is calculated by integrating the acceleration in a given period terminating at the third timing.

19. The impact detection method according to claim 18, wherein the velocity calculation circuit executes the filtering process using a filter expressed in equation 3,
[5]
$${a}_{Filtered \_ N} = \frac{m - 1}{m} * {a}_{Filtered \_ N - 1} + \frac{1}{m} * {a}_{N} \qquad ( 3 )$$
where a_{Filtered_N} is a value of an acceleration in an N-th sample after the filtering process, a_{Filtered_N-1} is a value of an acceleration in an N−1-th sample after the filtering process, a_{N} is a value of an acceleration in the N-th sample before the filtering process, and m is an integer of 2 or more.

20. The impact detection method according to claim 19, wherein the velocity calculation circuit calculates the velocity at the third timing according to equation 4,
[6]
$$v = {{\int }^{{T}_{1}}}_{{T}_{0}} {a}_{Filtered} dt \approx {\sum }_{{T}_{0}}^{{T}_{1}} {a}_{Filtered \_ N} \qquad ( 4 )$$
where v is the velocity, a_{Filtered} is a value of an acceleration at each timing after the filtering process, and a_{Filtered_N} is a value of an acceleration at the N-th sample after the filtering process in a predetermined period.
